(19) United States
(12) Patent Application Publication
(10) Pub. No.: US 2006/0155402 A1
(43) Pub. Date: Jul. 13, 2006

(54) 3d virtual manufacturing process

(76) Inventor: Dale Read, London (GB)

Correspondence Address: Arnold B Silverman;Eckert Seamans Cherin & mellot, 600 Grant Street, 44th Floor, Pittsburgh, PA, 15219, US

(21) Appl. No.: 10/502,004

(22) PCT Filed: Nov. 20, 2002
(86) PCT No.: PCT/GB02/05219

§ 371 Date: Jul. 27, 2005

(30) Foreign Application Priority Data
Nov. 21, 2001 (GB) 0127941.3

(51) Int. Cl. G06F 19/00

(52) U.S. Cl. 700/97

(57) ABSTRACT

A method of is disclosed of checking the feasibility or other properties of a process involving movement and/or assembly of items or components. The method comprises setting up, within a computer, in terms of corresponding sets of data, a virtual three-dimensional space and, in such space, virtual versions of the items or components concerned, represented by corresponding sets of data, and operating a program in the computer so as to manipulate the virtual items or components in that virtual space. The method makes it possible to determine, by operation of the computer, potential difficulties in manipulating corresponding real items or components in real space. The method can be used to set up, within a computer, a virtual factory in virtual manufacturing premises with dimensions corresponding to the real premises available, with virtual machinery with data as to dimensions, to positioning, movement and timing of such machinery, and virtual personnel with corresponding data as to dimensions, limits of safe movement, speed of movement and the like. It is thus readily possible to adjust the data which is variable, and thus represents degrees of freedom, to arrive at an efficient workable arrangement.

### TECHNICAL FIELD

THE PRESENT INVENTION relates to computer aided design, and is particularly, but not exclusively, applicable to the development of product, facilities and plant for the production of any new model of vehicle in the automobile industry.

### BACKGROUND OF THE PROCESS

Most automotive companies have developed their own processes for new model product development. In general, the process of development and for preparing for production of a new model comprises a series of stages or phases. All elements must be confirmed at each stage before proceeding to the subsequent phase.

A typical automotive company begins a new model program with ‘Strategic Intent’ to produce a vehicle of a certain size aimed at a certain market. The next milestones will be confirmation of this strategy and of the ‘Proportions & Hardpoints’ i.e. a basic shape and the essential features or ‘must haves’ are defined.

‘Program Approval’ is the point at which full confidence in the feasibility and financial investment required is achieved and the ‘go ahead’ is given. Critically, funding for manufacture of facilities (‘cutting metal’) is not available until this stage is reached.

There then follows a period in which the product appearance and design has to be finalised, and facilities to produce it developed and integrated into the manufacturing locations. One or more levels of prototype will be produced for drive tests and crash tests and various adjustments incorporated.

Eventually the vehicle will be signed off as ready for launch and then there will be a ramp up of production speed until full volume is achieved, known as Job One.

The duration of a new model program from the announcement of Strategic Intent until first volume product off line (Job#1) is typically 40-45 months.

The duration of such a process of development and preparing for production, from the announcement of Strategic Intent until the first example of the new model comes off the production line (Job#1) is typically 40-45 months. In this period, the product design has to be finalised, and facilities to produce it developed and integrated into the available manufacturing locations. Critically, funding for manufacture of facilities (‘cutting metal’) is not generally available until the Program Approval stage is reached.

In today's consumer-driven environment all automotive companies need to reduce their time to market and update cycles for new models to attract and retain customers. Significant progress has been made by simultaneous engineering methods in place of earlier methods under which product development, facility design and plant integration were successive independent tasks, each taking the output of the previous as an unchangeable given quantity. However, experience shows that launch delays and considerable unplanned expenditure still occur owing to incompatibilities not being discovered until integration in the physical form is attempted.

A need persists for early identification of potential problems with design concepts thus enabling resolution before any commitment of time or money to physical reality.

### SUMMARY OF THE INVENTION

It is an object of the present invention to provide an improved method of setting up a manufacturing facility by which the above-noted problems may be mitigated.

According to the present invention, there is provided a method of checking the feasibility or other properties of a process involving movement and/or assembly of items or components comprising setting up, within a computer, in terms of corresponding sets of data a virtual three-dimensional space and, in such space, virtual versions of the items or components concerned, represented by corresponding sets of data, and operating a programme in the computer so as to manipulate the virtual items or components in said virtual space and determine by operation of the computer, potential difficulties in manipulating corresponding real items or components in real space.

A preferred embodiment of the invention provides a repeatable methodology to apply digital 3D Computer Aided Design and Simulation to automotive “new model” program development, to save cost and time.

In accordance with this preferred embodiment the development of a new model in the automotive industry involves procedures, explained in detail below, and referred to herein as virtual manufacturing (VM), which use digital tools in an innovative way. The process will typically include the following stages:

| | | |
|---|---|---|
| SS | Strategic Support | Preliminary confirmation of feasibility of |
| | | new product program strategies. |
| AV | Assembly | Verify assembly feasibility of all identified |
| | Verification | product elements, irrespective of |
| | | manufacturing process or intended |
| | | destination environment. |
| MM | Manufacturing | Build manual and automated virtual |
| | Modelling | manufacturing processes around 3D product |
| | | data and simulate with motion in real time. |
| VF | Virtual Factory | Place all virtual facilities in their correct |
| | | positions inside a 3D model of the plant to |
| | | build a fully representative virtual factory. |
| PO | Prove Out | Physically verify feasibility as required of |
| | | concepts confirmed in VM. |
| VU | Virtual Update | Update VM environment in line with all |
| | | product, process-and factory changes from |
| | | Program Approval to Job#1 and beyond. |

The fundamental value of applying “Virtual Manufacturing” principles to take into account manufacturing considerations as early as possible in a “new model” program lies in the resulting time and cost savings arising from the ability to correct problems prior to production of physical prototypes.

There are several providers of suitable digital tools such as the eMPower (formerly known as RobCAD) software suite from Tecnomatix and Deneb from Dassault Systemes. The present invention, however, can use these tools in an innovative fashion to perform the steps described above.

An embodiment of the present invention is described below.

### DETAILED DESCRIPTION

The following describes the objectives, deliverables, pre-requisites and benefits involved in each phase of a virtual manufacturing process embodying the invention, as applied to ‘new model’ development in the automotive industry.

It is envisaged that the process described below will be undertaken or supervised by personnel skilled in 3D digital motion simulation in close cooperation with customer product development teams. The process includes working through a checklist which includes the elements below. It will be understood that, where possible and appropriate, the items in this checklist will be checked, in a virtual manufacturing environment established within a computer. The elements of the check list referred to might typically be:—

Assembly/Process sequence
Is the sequence (a) feasible and (b) optimal?

Robustness for fit and finish Is there any risk of damage to the part during build?

Quality impact
Have all quality issues been considered ?

Part tolerance
Are the tolerances between parts compatible?

Access for tooling
Is there sufficient clearance for the required tooling?

Ergonomics
Are the forces/positions required of the operator within acceptable limits?

Safety
Does the operator need any protection?

Manufacturing must and wants
Does the design meet all specified requirements?

Lessons learnt
Are all lessons learnt being applied?

Complexity
Is the complexity being kept at the planned level?

Fixing & locating strategy
Is the design in line with the program strategy?

Reusability & Commonality
Have directives for reuse of facilities and common product been maintained? Are the designs of components capable of being used in other models? Can manufacturing equipment, tooling, etc., be used in the manufacture of other models?

Cycle time
Can all the operations be performed within the cycle time? (On an assembly line the vehicles being assembled proceed along the line in series, so that the partially assembled vehicles must each spend in each work station the same amount of time, regardless of the time actually taken for the tasks to be performed in that workstation. This time is termed the cycle time)

Cost and investment
Is the affordable target being maintained?

Timing implications
Will changes have any effect on timing?
   Strategic Support (SS)

The first phase of the process utilises at a more general level all of the techniques described in detail below to validate strategic direction very early on in the design process. It takes a high level look at for example:
Styling envelope
Reusability targets
Manufacturing location selection
Supplier selection
Module selection

The aim at this stage is to highlight potential problems so that these can be removed early in the process in order to avoid major difficulties downstream. This stage is followed by stages in which these factors receive more detailed consideration, as explained in the following sections.

Assembly Verification (AV) Product Design Data Capture & Motion Simulation

Automotive companies now design product using 3D CAD modelling tools such as IDEAS, CATIA, Pro-Engineer etc. These enable the designers to view an image of a product or component, or a proposed product or component, from any angle with full surface modelling. The image in question is generated by computer, for example using ray tracing techniques and is displayed on a VDU, so that the designer can view a lifelike image of the product or component which at that stage may have no physical counterpart. That is to say the product or component viewed may be an entirely virtual entity. Traditional 2D drawings can be produced if required but the value of simultaneous engineering comes from sharing the full digital object with suppliers and designers of interfacing parts.

One restriction of these tools is that although real-time rotation on screen for design visualisation is possible, the object is essentially fixed. The overall digital package shows each part in its individual position and orientation so the details of the vehicle make up can be investigated and so that spatial violations or clearance problems in the final position of each component can hopefully be detected.

However, known techniques are not suited to detection of violations during the assembly process. The assembly sequence and motion path required to position the part may be overlooked by pure product designers, but can carry serious adverse implications for manufacturing feasibility. The present invention makes it possible to use customer product data and motion simulation tools to overcome this deficiency.

In carrying out the present invention in, for example, preparing for manufacture of a new model of motor car, a computing facility within which virtual manufacturing is to be established, developed and tested will have full access to digital design data previously established by the designer and intending manufacturer of the new model. This data will be held in a central database and accessed by a high speed data highway such as an IMI bridge from such computing facility which may be, for example, a high specification design workstation such as a Silicon Graphics, Sun or Hewlett Packard UNIX station.

Each component or module is downloaded and imported into the “virtual space” in the computing facility. (That is to say, numerical data representing the dimensions etc. of the respective components or modules and the positions of such components or modules in a three-dimensional reference frame (corresponding to their positions or proposed positions in the new model car) are loaded into the computer facility). A module is a cluster of components which for commercial reasons is brought in pre-assembled for insertion as a whole into a vehicle. The objects (i.e. the components or models) are subjected to the digital checklist tests above, both as standalone elements and in their interface with neighbouring parts.

Each object is given a starting point, trajectory and speed appropriate to its coming to rest in the assembled position against the neighbouring components assembled earlier in the assembly sequence. This trajectory will include orientation adjustments necessary to fix and locate the product.

The program under which the computing facility is running includes a part, referred to herein as a motion simulation tool, such that the facility will highlight (audibly and visibly) (by sound reproducing means and by VDU) if any parts of any objects try to share the same point in space at any time, i.e. if at any time during the trajectory there is a breach of a defined envelope, (in effect a collision of the part with another). This will bring out design flaws such as:
Two parts intended to interface will not mate correctly (or may not at extremes of tolerance).
A part cannot be brought into place without colliding with a previously assembled part.
An aperture is not large enough for a part to pass through e.g. a module for the interior of the vehicle (Instrument panel or seat) cannot go through the door.

If such flaws are detected by the program, different assembly sequences can be assessed and various angles and paths of insertion attempted to see if the collisions anticipated can be avoided.

Indeed the program may be arranged to try different assembly sequences and insertion paths and angles automatically in order to find the best, not only for collision avoidance, but also for time taken, complexity of insertion path, etc.

If no such difficulties are found, then the product design team will be cleared to proceed, whereas if any problems arise they will be reported and transferred to an “open issues” document to ensure that corrective action will be taken.

As will be understood from the above, 3D Virtual Manufacturing in accordance with the invention does not just discover such problems, but is a vital tool in resolving them.

It will be appreciated that, in effect, a feed-back loop exists at this point in the design process, in that if such a flaw as exemplified cannot be overcome by altering assembly sequence or insertion path the design of one or more components will have to be changed and the assembly verification stage repeated. This also can be done in a virtual way using computer aided design techniques.

Manufacturing Modelling (MM)—3D Design of Facilities

Once the product data is verified, optimal manufacturing facilities can be designed around it. For example tools for handling selected areas of the vehicle or components thereof can be designed with complementary areas for engagement with such selected areas. Thus such data can be used to establish perfect dimensions and mating profiles for:
Tooling and fixtures,
Handling aids and manipulators, for components including
Grippers for robot automation

The data will include information as to the location and form of ‘hard points’, i.e. locations which are intended to be engaged by predetermined elements in handling or conveying devices and which additionally provide a datum or reference with respect to which other tooling or handling devices are positioned.

Using accurate product data enables facility designers to ensure that there is sufficient clearance for tooling and all model variants are incorporated. Deflection of handling devices can be calculated using finite element analysis and compensated for.

The fixing positions for robots, tooling and manipulators will be optimised for reach within given standards and physical constraints. Conveyors, carriers, guarding and process equipment will all be built into the model in suitable positions.

Both manual and automated facilities will be modelled. Human or robot models are imported and animated to drive the product through the agreed path into position using the facilities designed.

The computer data representing the ‘virtual factory’ preferably includes ‘ergonomes’ allowing human personnel required in the real factory to be taken fully into account. Such ‘ergonomes’ are sets of data representing humanoid figures, (for example, with 60 joints and 10th to 90th percentile size range in both male and female versions). They are modelled carrying out the tasks their counterparts in the real factory will carry out, using MTM timing standards. The ergonomes have realistic reach and load bearing capabilities. They preferably even show fatigue if pushed beyond acceptable limits. Thus processes can be designed to be ergonomically comfortable for any manual operator. The walking path in the virtual factory (which will be kept clear of hazards) will be measured and optimised through appropriate placing of hand tools, stock and delivery carriers.

Similarly the computer model will include robot objects which are accurate numerical representations of robot devices proposed to be used in manufacture of the new car model, the robot objects accurately representing their real counterparts in dimensions, appearance and kinematic behaviour. The inertia and limits of inertia of the parts of the real robots about each axis are included in the computer model to correctly assess reach and cycle time.

Conveniently the computer model may break the task of establishing the virtual factory into the tasks of establishing individual manufacturing cells or workstations in the factory. Thus the computer may establish, for each proposed workstation, a 3D model of a cell or workstation which is visually representative and can be animated with real time motion to show the operation and interaction of all the various elements in order to produce the product or at least in order to complete the task or tasks required in that cell or workstation. The computer may also be arranged to establish, display and test a model of the whole factory or production facility to check or demonstrate that the operations of the individual cells or workstations are compatible, and/or to highlight conditions which may cause bottlenecks. The process can be demonstrated to and approved by the customer before any commitment of funds or cutting of metal. On approval all the design drawings can be generated from the model. The process can be viewed from any angle including operator eye view for training purposes.

Recovery strategies can be proposed and modelled for ensuring production even during a breakdown of automated facilities. Various alternatives can be assessed.

Using a tool such as Witness 2001, or similar, all processes, conveyors and cycle times can be imported with configuration and performance details and simulated in production. This will make it possible to demonstrate overall performance of the plant and can reveal conditions that may create bottlenecks.

Virtual Factory (VF)—Plant Environment Data Capture (Laser Scanning)

Real plant environment data is as much a key to designing optimal manufacturing facilities as real product data. In the context of the present invention great value comes from working with accurate 3D layouts and being able to determine which existing facilities can be reused.

A new, green field site could be designed in 3D from the outset and the digital data would be shared with the facility designers. However, such situations are rare. In most cases a new model or variant will be launched in an existing site, sometimes into existing running lines, where the data does not yet exist digitally.

3D laser scanning is preferably employed to capture real plant data. Detailed preparation is required to plan what features need to be included. This will be determined from the requirements of the simulation and from a site survey.

The scanning event itself involves setting up and operating a specialised piece of optical equipment. This spins around and elevates a mirror to capture distance and reflected intensity data from 12 million points over 60 degrees of elevation and the full surrounding 360 degrees. The scanner is then moved approximately six metres and the process repeated. This continues until the whole area of the real plant has been covered.

The images returned are 2D representations of the scanned area which may show considerable curvature and distortion. These are marked up by the simulation experts to show which are the key features that must be included in the model. The data is then filtered to remove clutter and the individual scans combined to produce one 3D model of the plant layout with the following data at a minimum:
Floor, walls and ceiling heights and shape
Door apertures
Building stanchions
Interior partitions, offices
Toilet blocks and rest areas
Staircases, mezzanine floors
Services—pipework (air/water/hydraulic), ducting, electrical conduit etc.
Parts delivery conveyors and carriers
Existing facilities that remain or for reuse

The simulation experts can then import into this digital 3D model of the real plant environment, data representing manufacturing and assembly facilities proposed to be installed in the real factory. It is possible to check, in a manner analogous to that described above for assembly of components, that each facility will fit into its intended destination and that reusing existing equipment as intended is viable. Identical manufacturing facilities can be designed once then imported into each plant that will produce that model. Other benefits include checking the delivery path of equipment to site (e.g. will it go through the doorway?) and also calculating the walking distances from workstations to toilet blocks and rest areas.

It is thus possible to set up a virtual factory, i.e.—a 3D model of the building with all facilities in place manufacturing virtual product. A ‘walkthrough tour’ can also be used for training purposes and up front risk assessment.

Prove Out (PO)

The main purpose of the virtual manufacturing proposed is to eliminate unnecessary prototypes. The visualisation in 3D of a process operating in real time with collisions avoided should be sufficient to give authority to proceed.

However, in certain cases, physical confirmation of process feasibility may be demanded either prior to program approval, or immediately after when funding for trials is released.

Prove Out cells are built in offline pilot areas using minimal equipment to demonstrate the workability of the physical counterpart of such cell in the virtual factory. A modular build philosophy is preferably used to ensure that all manufacturing equipment is reusable in the final (production) cell and disassembles into easily transportable units.

At the prove out stage it is also possible for prototype components or tools to be made, utilising the computer data established in the preceding stages and at the design stage, using the ‘rapid prototyping’ technique known per se.

Virtual Update (VU)

The virtual model is a continuously evolving entity. During the ongoing simultaneous engineering process and plant installation and launch preparation, there will certainly be numerous changes.

It is important to update the model, not just to have an accurate ‘as built’ representation for future expansion, but to prevent changes affecting downstream plans. All alterations to plan must be recorded and delivered to the development team for inclusion in the model. Thus if a late product change affects the way a facility must hold a part, or ducting needs to be rerouted near a facility, the people responsible can be informed of any potential problems before embarking on a course of action which may cause conflict.

Key Benefits

It is believed that, typically a method in accordance with the invention, as applied to new automobile development may:—
Cut up to six months off the product development timeline;
Eliminate time delays and cost of prototype production;
Save time wasted on design iterations by getting it right first time;
Allow design for mixed model production from the outset;
Make it possible to predict with confidence in assembly sequence and hours per car;
Make it possible to predict with confidence in cycle time per station and overall linespeed;
Make it possible to set out factory layout with confidence;
Make it possible easily to allow training with virtual simulations;
Make it possible easily to validate reusability and commonality proposals;
Make it possible easily to validate ergonomics and human factors before implementation expense;
Make it possible easily to highlight and reduce variable cost.

1. A method of checking the feasibility or other properties of a process involving movement and/or assembly of items or components comprising setting up, within a computer, in terms of corresponding sets of data, a virtual three-dimensional space and, in such space, virtual versions of the items or components concerned, represented by corresponding sets of data, and operating a programme in the computer so as to manipulate the virtual items or components in said virtual space and determine, by operation of the computer, potential difficulties in manipulating corresponding real items or components in real space.

2. A method according to claim 1 wherein the data representing each said virtual article or component includes data as to nominal dimensions and data as to tolerances for deviations from said nominal dimensions in the corresponding real items or components and wherein the computer is programmed to detect intrusion of an envelope of one virtual component or item into an envelope of any other said item or component during such manipulations, such an intrusion representing a collision between components.

3. A method according to claim 2 wherein, where such a collision is detected at an intermediate stage of moving a virtual component from one virtual position to another, along one path, said program is operable to test variations in such path in order to determine, if possible, a non-colliding path.

4. A method of setting up a manufacturing facility, such as an assembly line, comprising setting up, within a computer, in terms of corresponding sets of data, a virtual factory in virtual manufacturing premises with dimensions corresponding to the real premises available, virtual machinery comprising data as to dimensions, to positioning, movement and timing of such machinery, and virtual personnel with corresponding data as to dimensions, limits of safe movement, speed of movement and the like and adjusting the data which is variable and thus represents degrees of freedom of the facility to arrive at an efficient workable arrangement.

5. A method according to claim 4 including providing a visual display of the operation of the virtual factory.

6. A method according to any preceding claim and substantially as hereinbefore described.
